(19) United States
(12) Patent Application Publication
(10) Pub. No.: US 2022/0301261 A1
(43) Pub. Date: Sep. 22, 2022

(54) DEVICE AND METHOD FOR IDENTIFYING AND OUTPUTTING 3D OBJECTS

(71) Applicant: EMZA VISUAL SENSE LTD, GIVATAYIM (IL)

(72) Inventor: TOMER KIMHI, TEL AVIV (IL)

(21) Appl. No.: 17/693,479

(22) Filed: Mar. 14, 2022

(30) Foreign Application Priority Data
Mar. 16, 2021 (IL) 281554

(51) Int. Cl. G06T 17/10; G06T 13/20; G06T 19/00; G06T 7/70; H04N 13/279; G06V 40/16

(52) U.S. Cl. CPC G06T 17/10; G06T 13/20; G06T 19/006; G06T 7/70; H04N 13/279; G06V 40/171; G06T 2219/20

(57) ABSTRACT

A device, system, method and computer program product, the device including a capture device adapted to capture at least one image, a processor configured to extract at least one feature from the image, and an interface for providing the at least one feature, while avoiding providing the at least one image.

### TECHNICAL FIELD

The invention relates to imaging devices in general, and in particular to determining three-dimensional objects in images.

### BACKGROUND

Nowadays many devices and applications comprise and use cameras. Cameras are contained in mobile devices such as mobile phones, laptops, tablets, or the like, as well as in fixed devices such as security systems, admission control systems, and others.

Many devices execute advanced applications that require capturing images, and in particular require three-dimensional extraction of features from the captured image in the images, for example access control applications, background replacement as in video conferences, or the like.

Currently available technologies can use active illumination approaches, such as using structured light, which consume considerable energy. Other technologies use passive approaches which utilize two or more cameras to capture and stream images to a central processor, where feature extraction is performed followed by alignment and stereo matching, and further followed by determination of the depth for each matched feature.

Such technologies are expensive to install and to operate, and may require significant power as well as significant bandwidth for transmitting the images.

Additionally, such technologies are vulnerable to privacy breeches, since due to the images of a subject being transmitted, they may be subject to interception by a malicious entity.

### SUMMARY

One exemplary embodiment of the invention is a module including a capture device adapted to capture an image, a processor configured to extract one or more features from the image, and an interface for providing the features, while avoiding providing the image. The module is optionally embedded within a computing device. Within the module, one or more of the features is optionally a feature of an object. Within the module, the feature is optionally a facial or body feature of a subject captured in the image, and wherein the representation of the 3D object is utilized for puppeteering an avatar of the subject, thereby representing motions of the subject. Within the module, the feature is optionally an outline of a subject captured in the image, and wherein the 3D representation of the object is utilized for identifying and replacing a background of the subject captured in the first image or in the second image, in accordance with the outline. Within the module, the feature optionally includes one or more ears of a subject captured in the image, and wherein the representation of the 3D object is utilized for providing stereo sound to each of the ears of the subject, in accordance with the representation of the ears.

Another exemplary embodiment of the invention is a system including a first device including a first capture device and a first processor configured to extract a feature list from a first image captured by the first capture device, a second device including at least a second capture device for capturing a second image, a processor configured to receive the feature list, without receiving the first image, receive the second image, match and register a first feature from the first feature list with the second image obtain registration parameters, obtain a representation of a three dimensional (3D) description of a captured object based on the first feature, the second image and the registration parameters, and provide the 3D representation of the object, while avoiding providing the first image. Within the system, the feature is optionally a facial or body feature of a subject captured in the first image or in the second image, and wherein the representation of the 3D object is utilized for puppeteering an avatar of the subject, thereby representing motions of the subject. Within the system, the feature is optionally an outline of a subject captured in the first image or in the second image, and wherein the 3D representation of the object is utilized for identifying and replacing a background of the subject captured in the first image or in the second image, in accordance with the outline. Within the system, the feature optionally includes one or more ears of a subject captured in the first image or in the second image, and wherein the representation of the 3D object is utilized for providing stereo sound to each of the ears of the subject, in accordance with the representation of the ears.

Yet another exemplary embodiment of the invention is a system including a first device including a first capture device and a first processor configured to extract a first feature list from a first image captured by the first capture device, a second device including a second capture device and a second processor configured to extract a second feature list from a second image captured by the second capture device, a processor configured to receive the first feature list, without receiving the first image, receive the second feature list, match and register a first feature from the first feature list with a second feature from the second feature list to obtain registration parameters, obtain a representation of a three dimensional (3D) description of a captured object based on the first feature, the second feature and the registration parameters, and provide the 3D representation of the object, while avoiding providing the first image or the second image. Within the system, the object is optionally a facial or body feature of a subject captured in the first image or in the second image, and wherein the representation of the 3D object is utilized for puppeteering an avatar of the subject, thereby representing motions of the subject. Within the system, the object is optionally an outline of a subject captured in the first image or in the second image, and wherein the 3D representation of the object is utilized for identifying and replacing a background of the subject captured in the first image or in the second image, in accordance with the outline. Within the system, the object optionally includes at least one ear of a subject captured in the first image or in the second image, and wherein the representation of the 3D object is utilized for providing stereo sound to the ears of the subject, in accordance with the representation of the ears.

Yet another exemplary embodiment of the invention is a computer implemented method including performing steps by a first processor, the first processer included in a first device including also a first capture device, the steps including receiving a first image captured by the first capture device, extracting a first feature list from the first image, and outputting the first feature list without outputting the first image, performing steps by a second processor, the second processer included in a second device including also a second capture device, the steps including receiving a second image captured by the second capture device, extracting a second feature list from the second image, and outputting the second feature list, performing steps including matching and registering a first feature from the first feature list with the second image or features extracted therefrom to obtain registration parameters, obtaining a representation of a three dimensional (3D) object based on the first feature, the second feature and the registration parameters, and outputting the representation of the 3D object, while avoiding providing the first image or the second image. Within the method, the object is optionally a facial or body feature of a subject captured in the first image or in the second image, the method further including puppeteering an avatar in accordance with the facial or body feature, thereby representing motions of the subject. Within the method, the object is optionally an outline of a subject captured in the first image or in the second image, the method further including identifying and replacing a background of the subject in the first image or in the second image, in accordance with the outline. Within the method, the object optionally includes one or more ears of a subject captured in the first image or in the second image, the method further including providing stereo sound to the ears of the subject, in accordance with the representation of the ears.

Yet another exemplary embodiment of the invention is a computer readable storage medium retaining program instructions, which program instructions when read by a processor, cause the processor to perform a method including receiving a first image captured by the first capture device, extracting a first feature list from the first image, and outputting the first feature list without outputting the first image, performing steps by a second processor, the second processer included in a second device including also a second capture device, the steps including receiving a second image captured by the second capture device, performing steps including matching and registering a first feature from the first feature list with the second image or features extracted therefrom to obtain registration parameters, obtaining a representation of a three dimensional (3D) object based on the first feature, the second feature and the registration parameters, and outputting the representation of the 3D object, while avoiding providing the first image or the second image.

### BRIEF DESCRIPTION OF THE DRAWINGS

The invention will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings

FIGS. 1A and 1B are schematic illustrations exemplifying the usage of three dimensional (3D) feature representation for puppeteering, in accordance with some exemplary embodiments of the disclosure,

FIG. 2A is a block diagram of a device for capturing images and extracting features, in accordance with some exemplary embodiments of the invention,

FIG. 2B is a block diagram of a system for creating and using 3D object representations, in accordance with some exemplary embodiments of the invention, and

FIG. 3 is a flowchart of steps in a method for creating and using 3D object representations, in accordance with some exemplary embodiments of the invention.

### DETAILED DESCRIPTION

With the proliferation of capture devices and in particular digital cameras, and the advanced usage modes thereof in a variety of devices and applications, come new needs and challenges. One outstanding difficulty is that such applications and options should not compromise the privacy of captured subjects. Another difficulty is that many of the devices are not at all or not permanently connected to the electricity network, and thus need to be both inexpensive and efficient in order to provide the required services over long periods of time, between recharging or battery replacements.

The term object as used in this disclosure is to be widely construed to cover any human subject or another item present in a scene and captured by one or more capturing devices. An object may be represented in computerized systems as part of an image (or the whole image), or as any other data structure describing one or more aspects thereof.

The term feature as used in this disclosure is to be widely construed to cover any distinguishable elements or structures of an image, including points, lines, edges, corners or any other image parts that can be accurately and reliably located.

One technical problem of the disclosure relates to the need to provide information about an object or scene captured by a capturing device, while complying with privacy and efficiency requirements.

One example of this need relates to situations such as ID verification, access control, or the like, in which it is required to identify a three dimensional (3D) object or landmark in a captured scene. The object or landmark may be in the foreground of an image, such as a corner of an eye or mouth of a captured individual, a head, or the like, or to the background, such as any important landmark in the scene for example a piece of furniture, a landscape feature, or the like.

Some uses for 3D object recognition relate to protecting the privacy of a user. In one example, a participant in a video conference does not want his or her captured image to be provided to another party. However, the other party, such as another participant in the conference, would like to know how the first subject feels and how he reacts to the conference, thus providing a sense which is more similar to a face to face meeting.

Another example of such need relates to hiding and replacing the background of a video call participant, in order to protect another aspect of the participant's privacy, or another subject in the same premises. The detection of the background needs to be accurate, in order not to distort the transmitted image of the subject, while not exposing the actual background of the subject.

Yet another example of such need may be to identify any important feature in the background of a captured scene, which can be used for various purposes.

One technical solution of the disclosure relates to a device including a camera and a processor. The processor may be adapted to extract features from images captured by the capture device, and the device may output the features and disable output of the image or parts thereof. Such selective output may protect the privacy of the user, as well as provide efficiency as the image itself is not output, thereby reducing communication bandwidth.

The device may be used in a system for capturing and processing images, including extracting features from images of a scene captured by two or more cameras, and aligning and matching these features, thereby creating a three dimensional (3D) representation of imaged objects. The system may include two devices as described above, wherein at least one of the devices disables output of the image or parts thereof, allowing only the features to be output. The features extracted by the two devices may be output to an external processor of the system, which may register and combine them, and create a 3D representation of the objects to which the features belong. The features may include facial features such as eyes, pupils, cheekbones, nose, mouth outline, mouth corners, head outline, or the like, body features, animals, buildings, cars, room features such as door or window corners, scenery features or the like.

Each device may be adapted to output features extracted from the whole image, or from only a region of interest, for example a center of an image in an access control system.

One usage of such system including two or more devices is referred to as puppeteering and relates to a participant of a virtual teleconference being represented to other participants as an avatar, wherein the avatar mirrors the user's gestures. The mirroring enables the other participants to perceive the user's behavior and expression, without exposing the user's face.

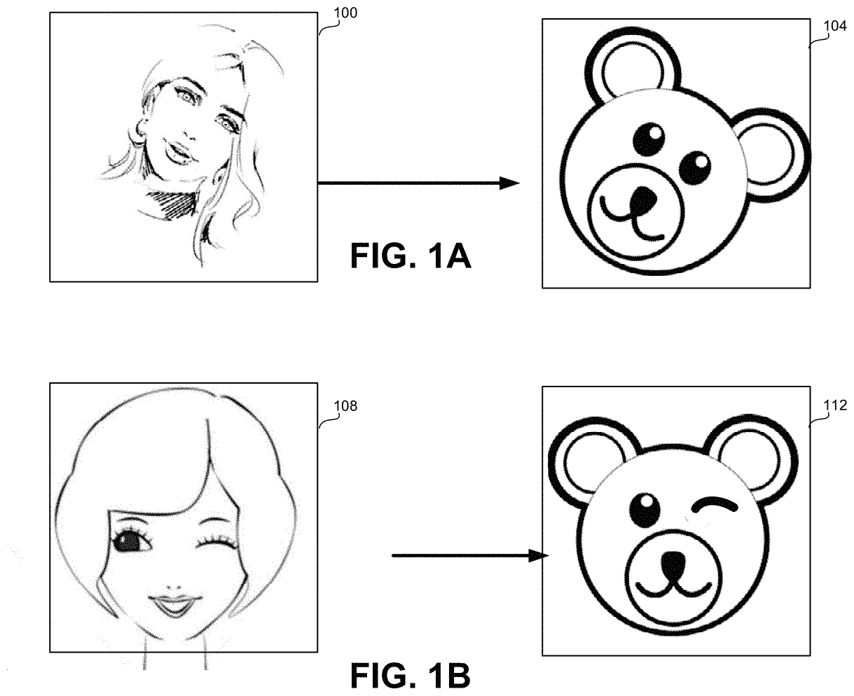

Referring now to FIGS. 1A and 1B, demonstrating puppeteering in accordance with some embodiments of the disclosure. FIG. 1A shows an image 100 of a user as captured for example during a virtual conference, wherein the user tilts her head. The user has chosen to be represented to other participants as an avatar of a teddy bear, therefore image 104 shows to the other participants an image 104 of the avatar with its head tilted.

Similarly, in FIG. 1B, image 108 captures the user when she winks, thus the avatar in image 112 is also winking.

Yet another usage relates to accurately identifying and locating one or more ears of a user (for example, if the user looks to the side only one ear may be located), such that sound may be accurately directed to each ear by a location-targeting audio device. For example, different audio signals may be created and directed to each ear of the user, thereby creating a high quality stereo effect. In another example, an audio signal of a phone call may be directed to the driver of a car, while the other passengers may continue listening to the car radio.

In the examples above, the subject's image is not required to be output at all, therefore the two devices may be adapted to only detect the features, rather than fully process the image.

Yet another usage relates to accurately identifying and representing the silhouette of a user's head in the 3D space, thus providing for accurate detection of the background of the user. Accurately detecting the background provides for replacement thereof with another background, without excluding parts of the user's head on one hand, and without exposing any of the background on the other hand, thus protecting the privacy of the subject and possibly other subjects in the environment.

One technical effect of the disclosure relates to a device that outputs only features extracted from an image, and to a usage thereof for creating and providing as output 3D descriptions of one or more captured objects or parts or characteristics thereof, while not providing as output the full captured images.

By separating the feature extraction from the alignment and matching of the features, the cost of the front-end feature extracting devices, for example a main processor of a device employing the capture device, may be significantly reduced. Additionally, since only features are transmitted rather than the full images, the required bandwidth may be reduced by orders of magnitude, thereby decreasing the operational cost and power consumption, which is particularly important when using wireless devices.

Another technical effect of the disclosure is that by providing as output and using only certain features rather than the full captured image, the privacy of the captured subject may be protected, while still allowing usage of the features as exemplified above.

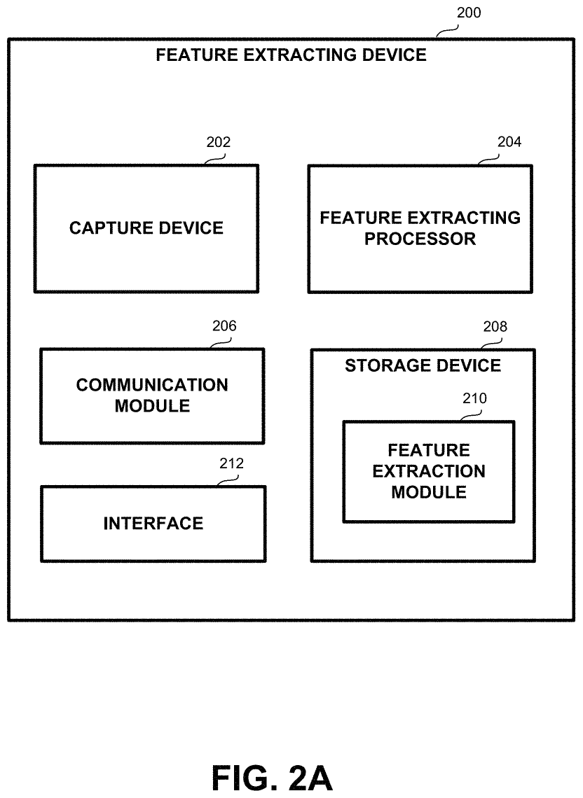

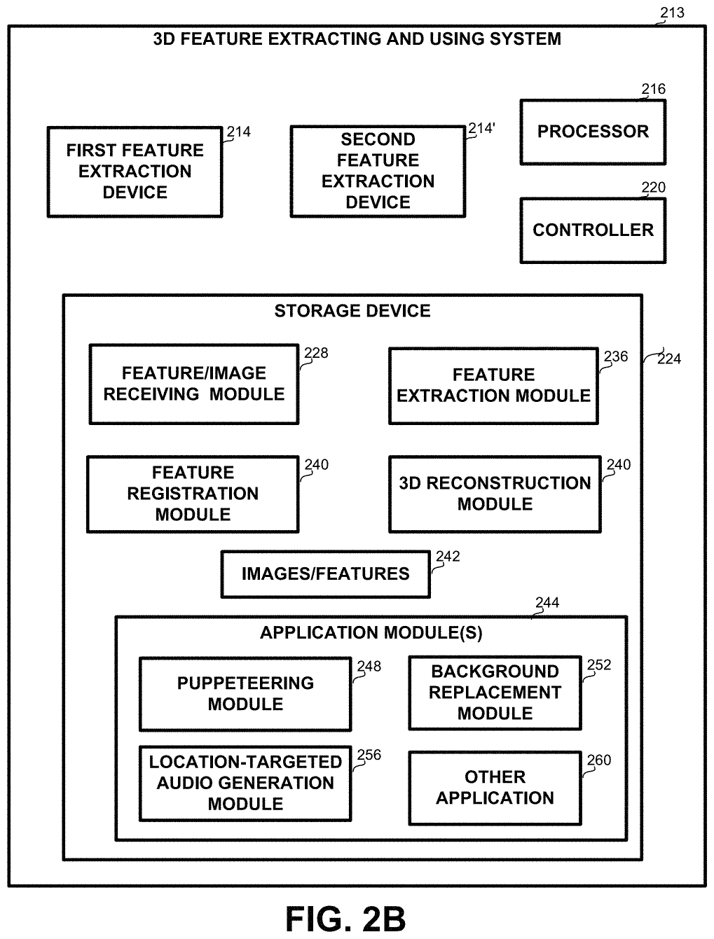

Referring now to FIG. 2A, showing a schematic block diagram of a feature-extracting device in accordance with some exemplary embodiments of the invention.

The device, generally referenced 200, may include a capture device 202, such as a camera, a video camera, a thermal camera, or the like, and a feature extraction processor 204.

Feature extraction processor 204 may include one or more Central Processing Units (CPUs), microprocessors, Graphical Processing Units (GPUs), electronic circuits, Integrated Circuits (IC) or the like. Feature extraction processor 204 may be a relatively small processor, sufficient for extracting features from images such as a digital signal processor (DSP), a microprocessor, a controller, or the like. Feature extraction processor 204 may use one or more algorithms to analyze the image and detect features, as detailed below.

Feature extracting device 200 may further include communication module 206, for implementing a communication protocol for transmitting the extracted features, as detailed in association with FIG. 2B below.

Feature extracting device 200 may further include storage device 208, such as a hard disk drive, a Flash disk, a Random-Access Memory (RAM), a memory chip, or the like. Storage device 208 may be implemented as part of or separately but operatively connected to feature extracting processor 204.

Storage device 208 may include feature extraction module 210 including computer instructions to be loaded to and executed by feature extraction processor 204, for extracting features from an image, or a region of interest thereof.

Feature extraction module 210 may employ techniques such as but not limited to edge detection, corner detection, principal component analysis (e.g., using eigenfaces), linear discriminant analysis, elastic bunch graph matching (e.g., using Fisherface), Local Binary Patterns Histograms (LBPH), Scale Invariant Feature Transform (SIFT), Speed Up Robust Features (SURF), scale selection, skin texture analysis, or the like. In some embodiments, machine learning models such as Neural Networks, convolutional Neural Networks, or Multi Task Convolutional Neural Networks (MTCNN) may be used for performing feature extraction.

Feature extracting device 200 may include interface 212 for transmitting the extracted features through communication module 206. Interface 208 may also include computer instructions to be executed by feature extraction processor 204 for transmitting the extracted features.

The output of feature extraction device 200 may include only the list of features rather than the captured image or a part thereof. The features may typically be in the order of magnitude of 10 KB per second instead of in the order of magnitude of 30 MB per second if a full image is output, thus saving not only processing power but also storage space and communication bandwidth.

Additionally, due to the output of feature extraction device 200 being only the extracted features and not the full image or a part thereof, the privacy of a captured object may be protected.

Referring now to FIG. 2B, showing a schematic block diagram of a system 213 for extracting and using 3D descriptions of a captured object or scene, in accordance with some exemplary embodiments of the invention.

The system, generally referenced 213, may be implemented within a privacy-proof sensor which does not violate the privacy of the subject, such as a system described in U.S. Pat. No. 10,831,926 filed Dec. 9, 2019 titled “Privacy Proof Visual Sensor”, and assigned to the same assignee as the current application.

System 213 may be implemented as part of any camera-equipped device, including but not limited to battery operated devices, embedded systems, or the like.

System 213 may include at least a first feature extraction device 214, and a second feature extraction device 214′, each of which may be implemented as feature extraction device 200.

First feature extraction device 214, and second feature extraction device 214′ should be set up such that the fields of view of their respective capture devices overlap at least partially, thereby providing for creation of a 3D description of objects captured by both capture devices.

System 213 may include processor 216, adapted to receive the extracted features from first feature extraction device 214, and second feature extraction device 214′, and generate a 3D reconstruction of captured objects. Processor 216 may be implemented as one or more processing devices, and may include one or more Central Processing Units (CPUs), microprocessors, Graphical Processing Units (GPU)s, electronic circuits, Integrated Circuits (IC) or the like. Processor 216 or part thereof can be located within capture system 213, but can also be separate from capture device system 200.

Processor 216 may be configured to provide the required functionality, for example by loading to memory and executing the modules stored on storage device 224 detailed below.

System 213 may include a controller 220 for controlling the input, for example setting operation parameters of the cameras or of the processing, or other operations. Controller 220 may be implemented in hardware, software, firmware, or any combination thereof.

Controller 220 may also be operative in interfacing with other systems or modules, displaying images, sending notifications, or the like.

System 213 may include a storage device 224, such as a hard disk drive, a Flash disk, a Random-Access Memory (RAM), a memory chip, or the like.

In some exemplary embodiments, storage device 224 may be implemented as two or more storage devices, whether collocated or located separately.

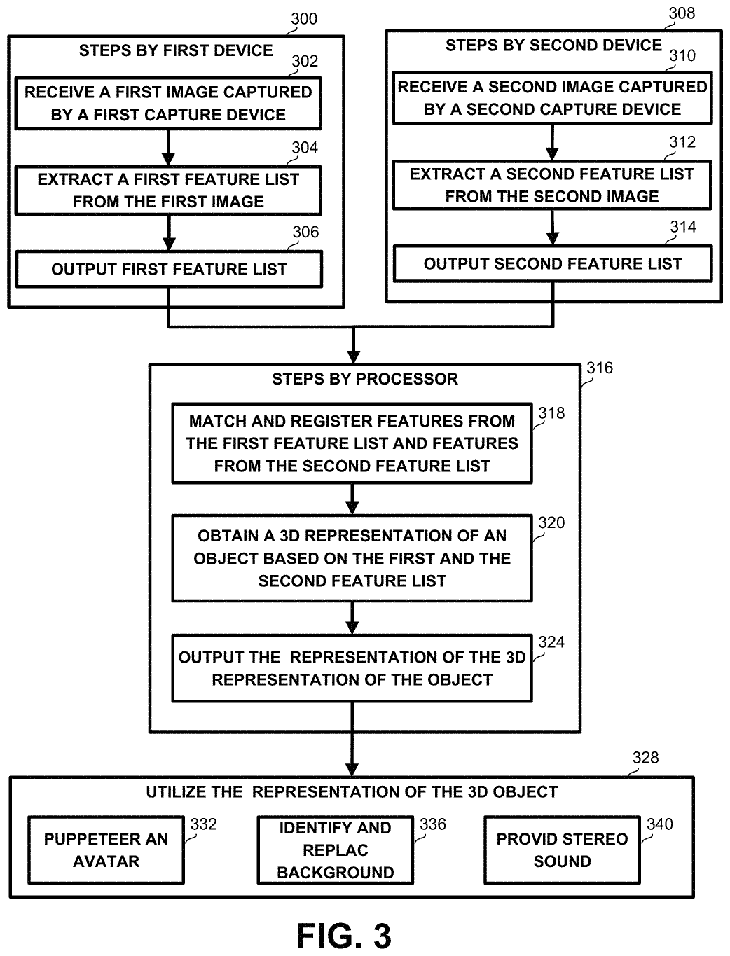

In some exemplary embodiments, storage device 224 may retain program code operative to processor 216 to execute processing protocols, programs, routines, or the like associated with any of the modules listed below or steps of the method of FIG. 3 below. The program code may include one or more executable units, such as functions, libraries, standalone programs or the like, adapted to execute instructions as detailed below. In alternative embodiments, the modules may be implemented as hardware, firmware or the like.

Storage device 224 may include feature/image receiving module 228, operative in receiving one or more features, images or parts thereof, for example, receiving extracted features from first feature extraction device 214 and second feature extraction device 214′ through respective interfaces 212. In some embodiments, processor 216 may also receive images directly from one or more, but not all the respective capture devices or from another source, such as another capture device or storage device.

Storage device 224 may include feature registration module 236, for registering two or more features received from first feature extraction device 214 and second feature extraction device 214′.

Storage device 224 may include 3D representation creation module 240, for combining the features received from first feature extraction device 214 and second feature extraction device 214′ using the registration parameters obtained by the feature registration performed by feature registration module 236 upon the features, for creating a 3D representation of captured objects. The 3D representation is enabled due to the difference in location, angle, capture parameters or other differences between the respective capture devices of first feature extraction device 214 and second feature extraction device 214′, for example using triangulation.

Storage device 224 may include image/features storage 242, for storing the received features, or images or parts thereof, received from any capture device.

The extracted features may be stored within images/features 260 of storage device 224 detailed below.

Storage device 224 may include application module(s) 244, including one or more modules for using the 3D representation created for the extracted features, including for example their measured location in the 3D space.

Application modules 224 may include, for example, a puppeteering module 248 for applying the 3D representation of the objects to an avatar, such that the avatar seems to imitate the gestures and motions of the user. The puppeteering enables a spectator realize the facial or body gestures and behavior of the subject, without being exposed to the subject's face.

In another example, Application modules 224 may include background replacement module 252, which may receive an accurate 3D representation of the outline of a captured subject and may thus accurately replace the background of the subject, leaving only the subject as captured, without the actual background behind.

In yet another example, Application modules 224 may include location-targeted audio generation module 256. Location-targeted audio generation module 256 may receive a 3D representation of the ears of a captured subject, or even an estimated location within each ear to which the sound should be directed, and may calculate sound to be directed to each ear, such that the user receives the stereo effect of the transmitted sound.

Application modules 224 may include any other application 260 that may make use of 3D representation of one or more features.

Referring now to FIG. 3, showing a flowchart of steps in a method for creating and using a 3D representation of objects within a captured scene, in accordance with some exemplary embodiments of the disclosure. The method may be performed by a system including at least two devices, as disclosed in association with FIG. 2A above.

Steps 300 may be performed by a first feature extracting device, such as feature extracting device 200.

On step 302, a first image may be received, which is captured by the capture device of the first feature extracting device. The first image may be a still image, a frame of a video stream, a thermal image, or the like. The first image may capture a subject or a scene, including features such as facial features, body features, scenery features, or the like.

On step 304, the first mage may be processed by the feature extracting processor of the first device, to extract at least a first feature list. If a human subject is captured, the feature list may include facial features, such as eyes or eye corners, nose, forehead, cheekbones, mouth, mouth corners, head outline, or the like. The features may also be a body feature, such as shoulders, hands, fingers, legs, or the like.

On step 306, the first feature list may be output, for example to processor 216 of FIG. 2B.

It will be appreciated that the term “list” is not limited to any specific data structure, and any other implementation of a collection may be used.

Steps 308 may be performed by a second feature extracting device, such as feature extracting device 200.

On step 310, a second image may be received, which is captured by a capture device of the second feature extracting device. The second image may also be a still image, a frame of a video stream, a thermal image, or the like. The second image may also capture a subject or a scene, including features such as facial features, body features, scenery features, or the like. The first image and the second image should at least partially overlap, in order to create 3D representations of objects captured in both images. The second image is captured at the same time as the first image, or within a predetermined threshold of time difference from the first image, such as 0.1 mSec, 1 mSec, 10 mSec, 100 mSec, 1 sec, or the like.

On step 312, the second image may be processed by the feature extracting processor of the second device, to extract at least a second feature list. If a human subject is captured, a feature in the list may be a facial feature, such as eyes, nose, forehead, cheekbones, mouth, mouth corners, head outline, or the like. The second feature may also be a body feature, such as shoulders, hands, fingers, legs, or the like.

On step 314, the second feature list may be output, for example to processor 216 of FIG. 2B.

Feature extraction performed on step 304 and 312 may use principal component analysis (e.g., using eigenfaces), linear discriminant analysis, elastic bunch graph matching (e.g., using Fisherface), Local Binary Patterns Histograms (LBPH), Scale Invariant Feature Transform (SIFT), histogram of oriented gradients (HOG), convolutional neural networks (CNN), Speed Up Robust Features (SURF), skin texture analysis, or any other technique that is currently known or will be developed in the future.

It will be appreciated that any further processing may also be performed as part of processing 304 or 312, and that processing 304 or 312 is not limited to detecting features.

It will be appreciated that steps 300 and steps 308 may be performed concurrently, such that images may be captured by the two capture devices within a same timeframe.

Steps 316 may be performed by a processor, such as processor 216 of FIG. 2B.

On step 318 the first feature and list he second feature list as received from the first device and the second device, respectively, may be matched, i.e., features from the first list may be compared to features from the second list, and one or more pairs of corresponding feature pairs may be identified. The pairs of corresponding features may be registered, e.g., the parameters, such as offset, rotation or scaling in one or more dimensions, which are required for matching one or more features extracted from the first image with one or more features extracted from the second image may be determined, for each pixel or area of the extracted features. If multiple features are extracted from the first image or from the second image, one or more matching trials may be performed to determine which feature(s) of the first image correspond to which feature(s) from the second image. It will be appreciated that multiple matchings may be determined, for example the subject's eyes in the first image may be matched to the subject's eyes in the second image, and similarly for other facial features. In some embodiments, registration parameters of one pair of matched features may also be used, possibly with local changes, for matching further features.

On step 320, based on the registration parameters, depth information of the features may be obtained, and a 3D representation of a matched feature may be created, for example calculated.

On step 324, the 3D representation of the feature may be output to any other module or system, and on step 328 the 3D representation may be used.

Usage of the 3D representation may include but are not limited to any one or more of the following exemplary usages

On step 332, puppeteering may be performed by applying the features or changes to the features to an avatar. The changes may include, for example, head tilting, smiling, winking, changing head position, opening and closing the mouth, or the like. Puppeteering thus enables a viewer to perceive the user's reactions, while avoiding exposing the user's image.

On step 336, a background surrounding a subject's image may be identified using a feature indicating the subject's silhouette. Once identified, the background may be accurately replaced with any required image, thereby avoiding exposing the subject's actual background.

On step 340, the location of a subject's ears may be accurately determined, such that different sounds may be provided to each ear of the subject, thereby creating an accurate stereo effect.

It will be appreciated that any other usage, or a combination of two or more usages, may be provided.

The invention may be a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including wired or wireless local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments described herein were chosen and described in order to best explain the principles of the invention and the practical application, and to enable others of ordinary skill in the art to understand the invention for various embodiments with various modifications as are suited to the particular use or uses contemplated.

What is claimed is:

1. A module comprising:
a capture device adapted to capture at least one image;
a processor configured to extract at least one feature from the image; and
an interface for providing the at least one feature, while avoiding providing the at least one image,
wherein the at least one feature is a facial or body feature of a 3D object captured in the at least one image, and wherein the representation of the 3D object is utilized for puppeteering an avatar of the subject, thereby representing motions of the subject, or
wherein the at least one feature is an outline of a subject captured in the image, and wherein the 3D representation of the object is utilized for identifying and replacing a background of the subject captured in the image or in a second image, in accordance with the outline.

2. The module of claim 1, wherein the module is embedded within a computing device.

3. The module of claim 1, wherein the at least one feature comprises at least one ear of a subject captured in the image, and wherein the representation of the 3D object is utilized for providing stereo sound to each of the at least one ear of the subject, in accordance with the representation of the at least one ear.

4. A system comprising:
a first device comprising a first capture device and a first processor configured to extract a feature list from a first image captured by the first capture device;
a second device comprising at least a second capture device for capturing a second image; and
a processor configured to
receive the feature list, without receiving the first image,
receive the second image,
match and register a first feature from the first feature list with the second image obtain registration parameters d,
obtain a representation of a three dimensional (3D) description of a captured object based on the first feature, the second image and the registration parameters, and
provide the 3D representation of the object, while avoiding providing the first image,
wherein the at least one feature is a facial or body feature of a 3D object captured in the at least one image, and wherein the representation of the 3D object is utilized for puppeteering an avatar of the subject, thereby representing motions of the subject, or
wherein the at least one feature is an outline of a subject captured in the image, and wherein the 3D representation of the object is utilized for identifying and replacing a background of the subject captured in the image or in a second image, in accordance with the outline.

5. The system of claim 4, wherein the at least one feature comprises at least one ear of a subject captured in the first image or in the second image, and wherein the representation of the 3D object is utilized for providing stereo sound to each of the at least one ear of the subject, in accordance with the representation of the at least one ear.

6. A system comprising:
a first device comprising a first capture device and a first processor configured to extract a first feature list from a first image captured by the first capture device;
a second device comprising a second capture device and a second processor configured to extract a second feature list from a second image captured by the second capture device; and
a processor configured to
receive the first feature list, without receiving the first image,
receive the second feature list,
match and register a first feature from the first feature list with a second feature from the second feature list to obtain registration parameters,
obtain a representation of a three dimensional (3D) description of a captured object based on the first feature, the second feature and the registration parameters, and
provide the 3D representation of the object, while avoiding providing the first image or the second image,
wherein the at least one feature is a facial or body feature of a 3D object captured in the at least one image, and wherein the representation of the 3D object is utilized for puppeteering an avatar of the subject, thereby representing motions of the subject, or
wherein the at least one feature is an outline of a subject captured in the image, and wherein the 3D representation of the object is utilized for identifying and replacing a background of the subject captured in the image or in a second image, in accordance with the outline.

7. The system of claim 6, wherein the object comprises at least one ear of a subject captured in the first image or in the second image, and wherein the representation of the 3D object is utilized for providing stereo sound to each of the at least one ear of the subject, in accordance with the representation of the at least one ear.

8. A computer implemented method comprising:
performing steps by a first processor, the first processer comprised in a first device comprising also a first capture device, the steps comprising
receiving a first image captured by the first capture device,
extracting a first feature list from the first image, and
outputting the first feature list without outputting the first image;
performing steps by a second processor, the second processer comprised in a second device comprising also a second capture device, the steps comprising
receiving a second image captured by the second capture device,
extracting a second feature list from the second image, and
outputting the second feature list; and
performing steps comprising
matching and registering a first feature from the first feature list with the second image or features extracted therefrom to obtain registration parameters,
obtaining a representation of a three dimensional (3D) object based on the first feature, the second feature and the registration parameters, and
outputting the representation of the 3D object, while avoiding providing the first image or the second image,
wherein the at least one feature is a facial or body feature of a 3D object captured in the at least one image, and wherein the representation of the 3D object is utilized for puppeteering an avatar of the subject, thereby representing motions of the subject, or
wherein the at least one feature is an outline of a subject captured in the image, and wherein the 3D representation of the object is utilized for identifying and replacing a background of the subject captured in the image or in a second image, in accordance with the outline.

9. The method of claim 8, wherein the at least one feature comprises at least one ear of a subject captured in the first image or in the second image, the method further comprising providing stereo sound to the ears of the subject, in accordance with the representation of the ears.

10. A computer program product comprising a computer readable storage medium retaining program instructions, which program instructions when read by a processor, cause the processor to perform a method comprising:
receiving a first image captured by the first capture device;
extracting a first feature list from the first image;
outputting the first feature list without outputting the first image; and
performing steps by a second processor, the second processer comprised in a second device comprising also a second capture device, the steps comprising
receiving a second image captured by the second capture device,
performing steps comprising,
matching and registering a first feature from the first feature list with the second image or features extracted therefrom to obtain registration parameters,
obtaining a representation of a three dimensional (3D) object based on the first feature, the second feature and the registration parameters, and
outputting the representation of the 3D object, while avoiding providing the first image or the second image,
wherein the at least one feature is a facial or body feature of a 3D object captured in the at least one image, and wherein the representation of the 3D object is utilized for puppeteering an avatar of the subject, thereby representing motions of the subject, or
wherein the at least one feature is an outline of a subject captured in the image, and wherein the 3D representation of the object is utilized for identifying and replacing a background of the subject captured in the first image or in the second image, in accordance with the outline.
